(19) United States
(12) Patent Application Publication
(10) Pub. No.: US 2009/0311102 A1
(43) Pub. Date: Dec. 17, 2009

(54) METHOD FOR PRODUCING THE ROTOR OF A WATER TURBINE, AND ROTOR

(75) Inventor: Hans-Gunther Poll, Sao Paulo (BR)

Correspondence Address: BAKER & DANIELS LLP;111 E. WAYNE STREET, SUITE 800, FORT WAYNE, IN, 46802, US

(73) Assignee: VOITH SIEMENS HYDRO POWER GENERATION GMBH & CO. KG, Heidenheim (DE)

(21) Appl. No.: 12/441,448

(22) PCT Filed: Aug. 8, 2007
(86) PCT No.: PCT/EP07/07003

§ 371 Date: Apr. 30, 2009

(30) Foreign Application Priority Data
Sep. 22, 2006 (DE) 10 2006 044 943.6

(51) Int. Cl. F03B 3/12; B23P 15/04

(52) U.S. Cl. 416/182; 29/889.71

(57) ABSTRACT

The invention relates to a method for producing a rotor for a Francis turbine, comprising a rotor base, a rotor ring and rotors.

The invention is characterized by the following features:
two disk bodies are formed from metal;
first one of the two disk bodies has an outside diameter which is equal to or slightly larger than the outside diameter of the rotor base;
a second one of the two bodies has an outside diameter whose outside diameter is equal to or slightly larger than the outside diameter of the rotor ring;
the two bodies are subjected to such a cutting machining process that the rotor base with blade stubs integrally formed thereon is produced from the one body, and the rotor ring with blade stubs integrally formed thereon is produced from the other body;
the blade stubs of the part forming the rotor base and the blade stubs of the part forming the rotor ring are arranged in such away that a blade stub each of the rotor base and a blade stub each of the rotor ring supplement each other to form a complete blade;
the two machined parts are associated with each other in such a way that the free ends of the blade stubs integrally formed on the rotor base are opposite of the free ends of the blade stubs integrally formed on the rotor ring;
the free ends facing each other are welded together.

The invention relates to the field of water turbines. It relates especially to a Francis water turbine. Pump turbines are also considered.

Increasingly higher demands are placed on such turbines concerning the efficiency and the operating range. This is closely linked to the strength of rotor and dimensional stability. Such a rotor is made of a rotor ring, a rotor base and a plurality of blades which are arranged between these two and are spatially curved.

The rotor must withstand all mechanical loads. Such mechanical loads are caused by the high hydraulic forces, mechanical influences such as by foreign bodies which are located in the flowing water, and by cavitation. Numerous efforts were made to reduce the likelihood of cavitation by providing a respective arrangement of the flow paths, and especially the blades. Reference is hereby made by way of example to WO 98/05863.

Production costs are of decisive importance under stiff international competition. They depend on the choice of the production method.

The invention is based on the object of providing a method with which a rotor for a Francis turbine can be produced, with all requirements being fulfilled concerning mechanical strength, dimensional stability and optimal hydraulic configuration, this under the lowest possible production costs.

This object is achieved by the method according to claim 1.

Accordingly, two parts are assumed in producing the rotor which are either cast or forged. The two parts are disks of a respective material, e.g. martensitic stainless steel. The disks are generally circular disks. Each circular disk itself is a monolithic body.

The one of the two circular disks has an outside diameter which is equal to the outside diameter of the ring of the rotor, or slightly larger. The other circular disk has an outside diameter which is equal to the outside diameter of the base, or slightly larger. The two circular disks are then subjected to machining. The rotor ring of the rotor to be produced is machined out of the one circular disk, in addition to the stubs of the blades which are associated with the ring. The rotor base is machined out of the other disk, in addition to the stubs of the blades which are associated with the rotor base. The stubs of the base and ring are arranged in such a way that one blade stub of the base and one of the ring supplement each other to form a complete blade. Mechanical working occurs by means of CNC machines for example. Two parts of the rotor to be produced are obtained by mechanical working. These parts are joined with each other that the free ends of the blade stubs of the rotor base are opposite to the free ends of the blade stubs of the rotor ring. The free ends of the blade stubs are then welded together.

The intersecting surface along which the blade stub ends are joined can be a place which extends perpendicular to the rotational axis of the rotor. It can also be a conical surface which tapers downwardly, relating to the static rotor. A concave conical surface has proven to be especially advantageous.

The following is achieved by the invention in detail:

The production costs are far lower in comparison with conventional production methods.

The internal stresses in the material of the rotor are lower than in conventionally produced rotors; the inner homogeneity of the material is better than in a monobloc casting, the material structure is optimal and the residual stresses are minimal.

The homogeneity of the material is high.

The two parts of the rotor to be joined can be produced without any production risk, i.e. the production method in accordance with the invention leads to the desired result with a high amount of security, this being with minimal rejects.

The free ends of the blade stubs are situated upwardly during the casting as well as the forging of the two mentioned parts of the produced rotor. If there are shrinkage cavities or gas bubbles, they are also situated at the top, i.e. at the free ends of the blade stubs; with respective overdimensioning, these areas are removed during mechanical working.

Production can occur rapidly, thus leading to short delivery times.

The invention is now explained in closer detail by reference to the drawings which shown in detail:

FIG. 1 shows a Francis turbine in an axial sectional view;

FIG. 2 shows the rotor of the Francis turbine on an enlarged scale;

FIG. 3 shows the shape of the free end of a blade stub;

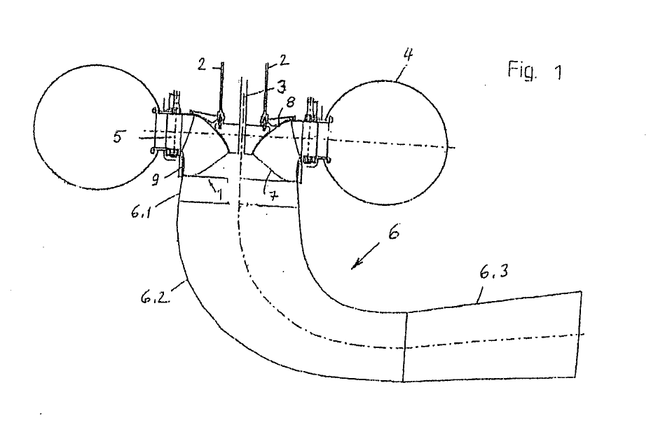

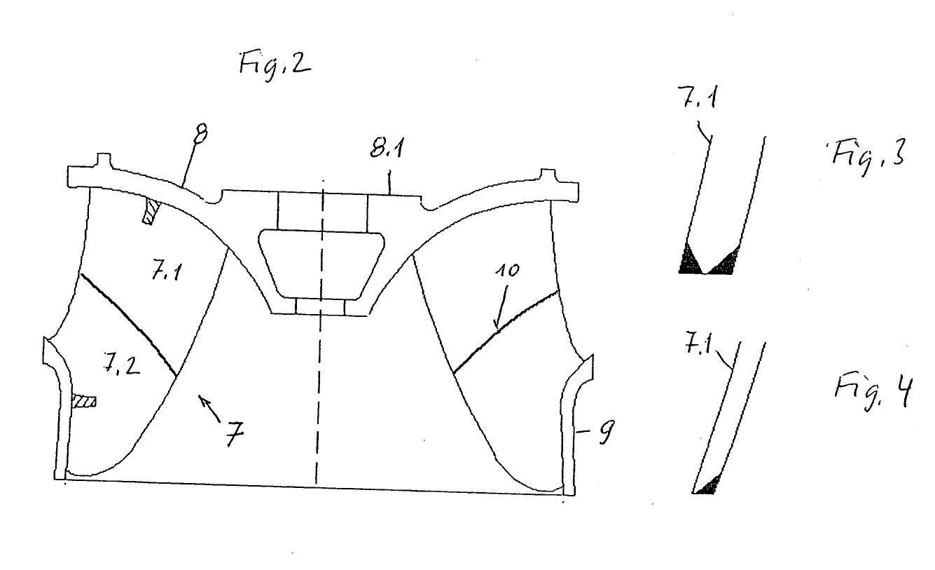

FIG. 4 shows the free end of another blade stub;

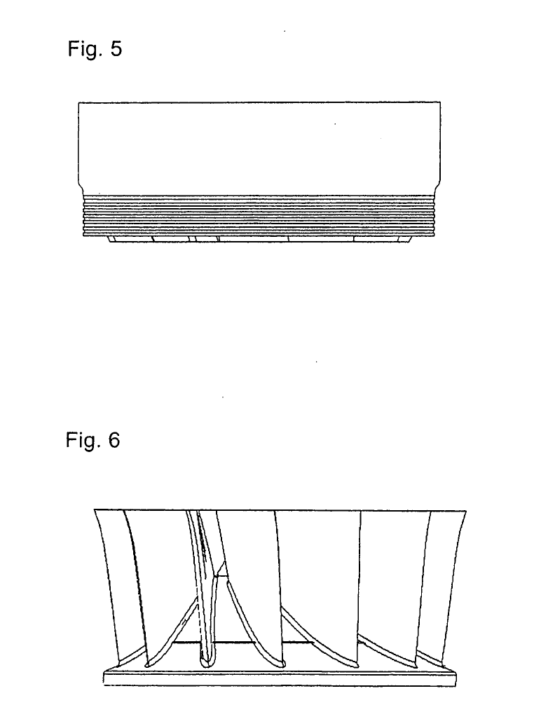

FIG. 5 shows a blank as an intermediate product for producing the rotor base with associated blade stubs;

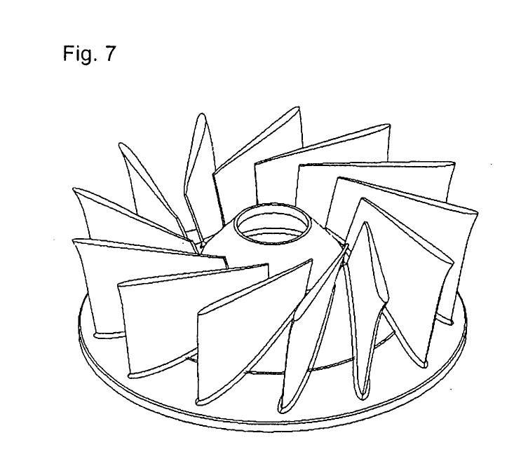

FIG. 6 shows a blank as an intermediate product for producing the rotor ring with associated blade stubs;

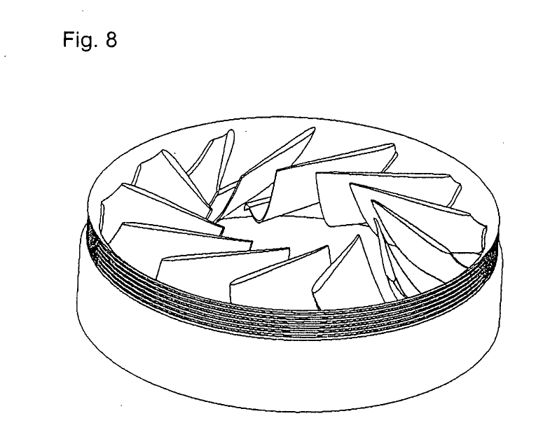

FIG. 7 shows the one completed part of the rotor, comprising the rotor base with blade stubs in a perspective view;

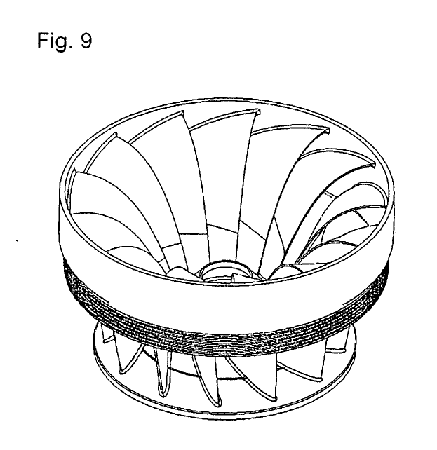

FIG. 8 shows the other completed part of the rotor, comprising the ring with blade stubs in a perspective view;

FIG. 9 shows the finished blade joined from the two parts in a perspective view.

The Francis turbine as shown in FIG. 1 is arranged as follows: The rotor 1 is rotatably held about a rotational axis 3. Rotor 1 is enclosed by a spiral housing 4. Furthermore, the rotor 1 is provided upstream with a ring of guide blades.

The turbine comprises a draft tube 6. It comprises an inlet diffuser 6.1 with a bend 6.2 connected thereto and a suction box connected to the latter.

The rotor comprises a plurality of rotors 7, further a rotor base 8 and a rotor ring 9.

The rotor base 8 is suspended by means of tension rods 2.

FIG. 2 shows the relevant parts of the rotor, which are the blade 7, the rotor base 8 and the rotor ring 9. Rotor base comprises a hub part 8.1 which encloses a shaft in a torsionally rigid manner (not shown here).

Each blade 7 is joined from two blade stubs, which is a blade stub 7.1 which is integrally formed with the base 8 and a blade stub 7.2 which is a component of the rotor ring 9. The numerous blade stub pairs 7.1 and 7.2 are joined along a contact surface 10 by welding.

FIG. 5 shows a blank 11. It is an intermediate product for the rotor base 8. FIG. 6 shows a blank 12 as an intermediate product for the rotor ring 9. The two blanks 11 and 12 substantially have the shape of circular disks. They are produced by casting or forging. They are subjected to mechanical working, e.g. by means of CNC machines. The rotor 8 with blade stubs 7.1 formed on the same is produced from blank 11. The ring 9 with the blade stubs 7.2 formed on the same is produced from blank 12.

FIGS. 7 and 8 show both parts which are to be joined after their production. FIG. 7 shows the rotor base 11 with blade stubs 7.1 formed thereon, and FIG. 8 shows the rotor ring 12 with blade stubs 7.2 formed thereon.

These two parts are now joined, and one of the two parts obviously needs to be brought to such a position that the ends of the blade stubs 7.1, 7.2 face each other.

The free ends of the blade stubs 7.1, 7.2 can be prepared in different ways for welding, see FIGS. 3 and 4. In the case of thicker blade profiles, the arrangement according to FIG. 3 will rather be used; in the case of thinner blade profiles, rather the shape according to FIG. 4.

All contact surfaces 10 lie in the present case on the jacket surface of a cone (conical surface) which is concave. The contact surface 10 could also be arranged differently. It could lie on a conical surface for example which is purely conical, and thus neither concave nor convex. The contact surface between two mutually facing blade stubs 7.1 and 7.2 would thus be a straight line.

The contact surface 10 could also lie between the entirety of all blade stubs in a horizontal plane which thus extends perpendicular to the rotational axis 3.

In the present case, the contact surface extends in such away that it is shown in FIG. 1 a line which drops from the inflow edge of the individual blades 7 to the outflow edge. It could also rise.

It is obvious that the free ends of the joined blade stubs 7.1.7.2 are machined again in the area of the weld seams after the welding, to the extent as is necessary.

### LIST OF REFERENCE NUMERALS

1 Rotor
2 Tension rod
3 Rotational axis
4 Spiral housing
5 Guide blades
6 Draft tube
6.1 Inlet diffuser
6.2 Bend
6.3 Suction box
7 Rotors
7.1 Blade stubs which are formed on the rotor base
7.2 Blade stubs which are formed on the rotor ring
8 Rotor base
9 Rotor ring
10 Contact surface
11 Blank for rotor base
12 Blank for rotor ring

1: A method for producing a rotor made of two parts for a Francis turbine, comprising a rotor base, a rotor ring and rotors, characterized by the following features:
1.1. two monolithic disk bodies are formed from metal;
1.2. a first one of the two disk bodies has an outside diameter which is equal to or slightly larger than the outside diameter of the rotor base;
1.3. a second one of the two bodies has an outside diameter whose outside diameter is equal to or slightly larger than the outside diameter of the rotor ring;
1.4. the two bodies are subjected to such a cutting machining process that the rotor base with blade stubs integrally formed thereon is produced from the one body, and the rotor ring with blade stubs integrally formed thereon is produced from the other body;
1.5. the blade stubs of the part forming the rotor base and the blade stubs of the part forming the rotor ring are arranged in such a way that a blade stub each of the rotor base and a blade stub each of the rotor ring supplement each other to form a complete blade;
1.6. the two machined parts are associated with each other in such a way that the free ends of the blade stubs integrally formed on the rotor base are opposite of the free ends of the blade stubs integrally formed on the rotor ring;
1.7. the free ends facing each other are welded together.

2: A method according to claim 1, characterized in that the blanks for the rotor base and for the rotor ring are produced by casting or by forging.

3: A method according to claim 1, characterized in that the contact surfaces which form the free ends of a pair of blade stubs with each other lie in a horizontal plane which extends perpendicular to the rotational axis of the rotor.

4: A method according to claim 1, characterized in that the contact surfaces formed between the free ends of mutually adjacent blade stubs lie in a conical surface.

5: A method according to claim 4, characterized in that the conical surface is concave.

6: A rotor for a Francis turbine, comprising blades, a rotor base and a rotor ring comprising the following features:
6.1. the rotor is joined from two parts which are monolithic per se;
6.2. the one part comprises the rotor base with blade stubs formed thereon;
6.3. the second part comprises the rotor ring with blade stubs formed thereon;
6.4. the blade stubs are joined with each other by welding at their free ends, so that one blade stub each of the rotor base and one blade stub each of the rotor ring supplement each other to form a complete blade of the rotor.

7: A method according to claim 2, characterized in that the contact surfaces which form the free ends of a pair of blade stubs with each other lie in a horizontal plane which extends perpendicular to the rotational axis of the rotor.

8: A method according to claim 2, characterized in that the contact surfaces formed between the free ends of mutually adjacent blade stubs lie in a conical surface.

9: A method according to claim 8, characterized in that the conical surface is concave.
